(19) United States
(12) Patent Application Publication
(10) Pub. No.: US 2008/0163117 A1
(43) Pub. Date: Jul. 3, 2008

(54) User Interface for Appointment Scheduling System Showing Appointment Solutions Within a Day

(75) Inventors: Geert Machtelinck, Mortsel (BE); Marc Coomans, Mortsel (BE)

Correspondence Address: HOUSTON ELISEEVA, 4 MILITIA DRIVE, SUITE 4, LEXINGTON, MA, 02421, US

(73) Assignee: QUADRAT, Mortsel (BE)

(21) Appl. No.: 11/817,637

(22) PCT Filed: Feb. 17, 2006
(86) PCT No.: PCT/EP2006/060038

§ 371 Date: Aug. 31, 2007

Related U.S. Application Data
(60) Provisional application No. 60/666,045, filed on Mar. 29, 2005.

(30) Foreign Application Priority Data
Mar. 4, 2005 (EP) 05101682.2
Mar. 4, 2005 (EP) 05101703.6

(51) Int. Cl. G06F 3/048; G06Q 10/00

(52) U.S. Cl. 715/822; 715/810; 715/833; 705/2

(57) ABSTRACT

Two parallel time lines are displayed. On a first time line all possible solutions for scheduling an appointment within a preset period of time, such as a day or a part of the day, are displayed. Such a possible solution can be selected. Triggered by such a user selection of one of the displayed possible solutions a period surrounding the selected possible solution is blown up and displayed on the second time line. Possible solutions within the period on said second time line are indicated and can also be selected.

### FIELD OF THE INVENTION

The present invention relates to a user interface for an appointment scheduling system.

Appointment scheduling systems can be applied in medical institutions, where appointments need to be scheduled for patients, taking into account a multitude of constraints such as the availability of personnel and equipment, and of the patient himself.

### BACKGROUND OF THE INVENTION

In appointment scheduling systems a convenient user interface greatly improves the ease and efficiency for the user.

One of the items a user is interested in is to have a visual display of all appointment solutions for a particular scheduling task within a period of time such as a day.

Important challenges are:
to incorporate ALL solutions in a single day view,
to minimise user navigation to find an adequate solution
to maximise intuitiveness of the solution
to have a space-saving solution

The user is typically confronted with the following problems:
he has to be able to communicate easily and directly to the patient which are the possible solutions, while being exhaustive as much as possible p1 he has to be able to answer typical question such as what is the earliest solution (occasionally with constraints such as ‘within the morning’, ‘in the afternoon’), what is the latest solution for that day (in the morning, in the afternoon) p1 when a certain start time is satisfactory, he has to be able to switch easily from one resource to another if an alternative resource is available, p1 in case of combined appointments, being multiple exams booked simultaneously with specific interval requirements, he has to see all solutions in a similar way

Existing scheduling applications show appointment solutions within a day in one of the following ways:
1) as a flat list of solutions, typically sorted chronologically, or
2) as agenda days of a certain resource or resource combination—agenda days are typically linear timelines, being shown vertically or horizontally.
3) as a two-dimensional view of the resource combination's combined resulting schedule with the y-axis showing the day hours & the x-axis showing the minutes. This view is implemented in the scheduling scheme sold by Agfa-Gevaert N.V. under the trade name QPlanner.

Additionally, mostly these solutions don't satisfy all search constraints: often there is a post-check required on the selected solution with regards to e.g. patient occupation or inter-procedural constraints. Such post-checks do hinder the scheduling process tremendously, because an adequate solution found (often with some difficulties), may turn out to be problematic after post check.

The above-described existing presentations of the solutions of an appointment scheduling system lack to solve one or more of the problems mentioned higher.

(1) In case of a flat list of solutions, typically sorted chronologically the following problems still exist.
An exhaustive flat list of solutions within one day can consist of several hundreds of possibilities (taking into account all possible resource combinations and even more in case of combined appointments. This cannot be easily communicated to the patient.
This presentation of results does not provide an immediate view from which a response e.g. to the question what is the latest solution in the morning, or the earliest in the afternoon, can be deduced.

(2) In case of presentation in the form of agenda days of a certain resource or resource combination, in which agenda days are typically presented as linear vertically or horizontally positioned timelines, the following problems still exist.
Considering all possible resource combinations, one would still be left with several tens of lines of resource combinations, each showing their agenda—in case of exam combinations, the possible combinations grow exponentially to hundreds of lines. This doesn't give a workable view, so current state of appointment schedulers are not exhaustive in their solution offering.
Questions such as “what is the earliest solution (in the morning, in the afternoon)”, “what is the latest solution for that day (in the morning, in the afternoon)”, etc. . . . cannot be easily answered.
Additionally, when the patient is e.g. doubting between the earliest or latest solution of that day (typically because it is just before or after the patient's workday), the user is confronted with scrolling between the earliest & latest solutions
Typically appointment durations can be 5 to 10 minutes. This means that a high resolution on the agenda is needed to be able to select well on the offered solutions.

(3) The overview of possible solutions offered by the product QPlanner of Agfa-Gevaert N.V. can still be optimised because of the following elements.
The system does not offer a direct view on all solutions since each resource combination is shown in a different tab, so a user has to run through each tab to get a complete view,
The system has a limitation to 10 resource combinations (so 10 tabs) and this only for single exam scheduling. So it does not provide an exhaustive solution.
Only one solution is shown in case of combined exam scheduling. For this aspect it is likewise not exhaustive.
The system provides a two-dimensional day-view, which is compact and avoids scrolling, but on the other hand is not intuitive.

It is an aspect of the present invention to provide an user interface for an appointment scheduling system that shows appointment solutions within a certain period of time, e.g. within a day, in an optimised way relative to the prior art solutions.

US 2005/004815 A1 generally discloses an appointment scheduling system using time segmented propositions. The application does not disclose a user interface of the kind disclosed by the present invention.

U.S. Pat. No. 5,860,067 discloses a user interface displaying a scale for scheduling a resource, allowing to input a time segment by pointing with the input unit a segment having a position and a length to indicate hours or days; in response to an inputted segment, available solutions are displayed. The interface features scale enlargements in a supplementary, separate window to display the time scale with more details.

US 2003/016248 A1 described zooming in a conventional visual event calendar: the time scale is zoomed, i.e. its granularity increased or decreased, while scheduling area remains functional, including displaying ‘busy bars’ and scheduling interaction; a scroll box indicates part being scrolled and allows direct manipulation for scrolling.

The article “Zooming on visual calendar data” published in Research Disclosure, Kenneth Mason Publications, Westbourne, G B, Vol. 329, No. 19, September 1991 discloses simultaneous zooming and panning of content in a graphical user interface display, by means of a scalable scroll control of a time line.

By click-dragging either one of the scale controllers, the scale of timeline may be changed. The selected fields and times are highlighted up to the current finest-resolved selected time. Finer scales and units are dim, in comparison.

### SUMMARY OF THE INVENTION

The above-mentioned aspects are realized by a user interface as set out in claim 1.

In a user interface according to the present invention possible solutions for scheduling an appointment within a preset period of time (such as a day or a part of the day—morning, afternoon, a number of consecutive hours) are displayed on a first time line. Responsive to user selection of one of said displayed possible solutions, for example by clicking on such a possible solution, a period surrounding the selected possible solution is blown up and displayed on a second time line. This second time line is preferably parallel with the first time line.

A more detailed view of all possible solutions within the blown up period on the second time line is given.
These possible solutions are arranged to be selectable by the user.

In the context of the present invention a solution is considered a ‘possible solution’ when it expresses a time or time slot on which all preset constraints are met and on which the required resources (radiology room, examination equipment, doctors, operators) are available (the time or time slot is ‘free’) so that scheduling of an event on such a time or time slot is allowable.

As a result of an appointment scheduling operation performed for a certain patient in most cases more than one solution is obtained.

The appointment scheduling system creates a so-called solution space, which is a collection of all solutions that are applicable for a given resource taking into account a given set of constraints.

An example of a scheduling engine for an appointment scheduling system is described extensively in an application entitled ‘Method for processing linked lists of time segments’, filed by the same applicant on the day of filing of the present application.

Specific features for preferred embodiments of the invention are set out in the dependent claims.

Further advantages and embodiments of the present invention will become apparent from the following description and drawings.

### BRIEF DESCRIPTION OF THE DRAWINGS

FIG. 1 shows an embodiment (a double time line) according to the present invention,

FIG. 2 is another example of a double time line according to the present invention,

FIG. 3 shows a double time line in which a specified period is zoomed to a 5 minutes resolution,

FIG. 4 shows a double time line in which a specified period is zoomed to a 10 minutes resolution,

FIG. 5 is a screen shot showing an overview of resource combinations for a certain period of the day,

FIG. 6 is a screen shot showing each resource combination for a particular choice made on the overview illustrated by the screen shot of FIG. 5,

FIG. 7 describes a set of actions related to resources and connected by comprising, relational and sequential links;

FIG. 8 describes a reduced set of actions that is left after working out the relational links according to a preferred embodiment;

FIG. 9 describes a reduced set of actions that is left after working out the relational and comprising links according to a preferred embodiment;

FIG. 10 describes a reduced set of actions that is left over after working out the relational, comprising and sequential links according to a preferred embodiment;

FIG. 11 describes a set of time windows associated with actions;

FIG. 12 demonstrates the processing of a relational link according to a preferred embodiment;

FIG. 13 demonstrates the processing of a comprising link according to a preferred embodiment;

FIG. 14 demonstrates the processing of a sequential link with a preceding action according to a preferred embodiment;

FIG. 15 demonstrates the processing of a sequential link with a following action according to a preferred embodiment;

FIG. 16 demonstrates the processing of a sequential link with a following action, taking into account slack time according to a preferred embodiment;

FIG. 17 shows an example of processing a relational link according to a preferred embodiment;

FIG. 18 shows another example of processing a relational link according to a preferred embodiment;

FIG. 19 shows three examples of processing a comprising link according to a preferred embodiment;

FIG. 20 shows an example of the processing of time windows according to a preferred embodiment;

FIG. 21 shows an example of using deductive logic;

FIG. 22 shows an example of using inductive logic;

FIG. 23 shows a data processing system according to a preferred embodiment of the current invention.

### DETAILED DESCRIPTION OF THE INVENTION

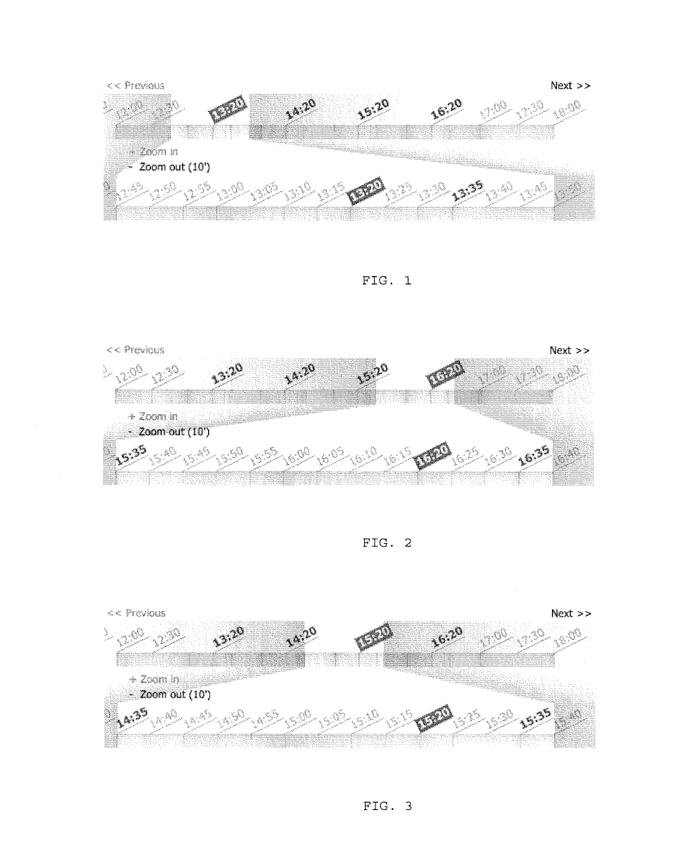

FIGS. 1 and 2 are displays pertaining to an embodiment of a user interface according to the present invention.

A day view was constructed, showing only appointment start times as solutions. Sliding through the day is provided by means of “previous”, “next” arrows.

When a certain time of day contains at least one solution, it is highlighted (or put in bold), otherwise it remains in regular font style.

Taking into account the 5 to 10 minutes resolution to click on a certain time of day to book an appointment, this view would have to be a very long timeline with scrolling required.

That way of working is too time consuming to fulfill the demand of a complete appointment offering to the patient.

Combining the requirement of overview, with the practical need of clicking on a concrete time of the day, a double timeline was constructed:

the upper line gives an overview of all solutions, by means of the highlighted appointment start time. It is possible to select such a solution. This upper view is typically constructed as to show the borders of the solution space, namely: the first and last solution of the morning and the first and last solution of the afternoon (tackling typical patient demands—see above)

depending on the position of this selection on the upper line, a zoom light moves with and indicates on a bottom time line the start-times around the clicked area, possible solutions again being high-lighted or displayed in bold.

With the zooming light connecting both lines, an intuitive navigation is created.

At the same time it allows fast interaction to book on a certain time of day: a maximum of 2 clicks is needed (one on the upper & one of the bottom line), avoiding unnecessary scrolling (One click solution selection is possible if the solution was already displayed on the first timeline, typically for the ‘border-solutions’)

Next to that, the zooming resolution can be initialised/modified by pressing on the zoom in or zoom out functions:

Zoomed to 5 minutes resolution: see FIG. 3.

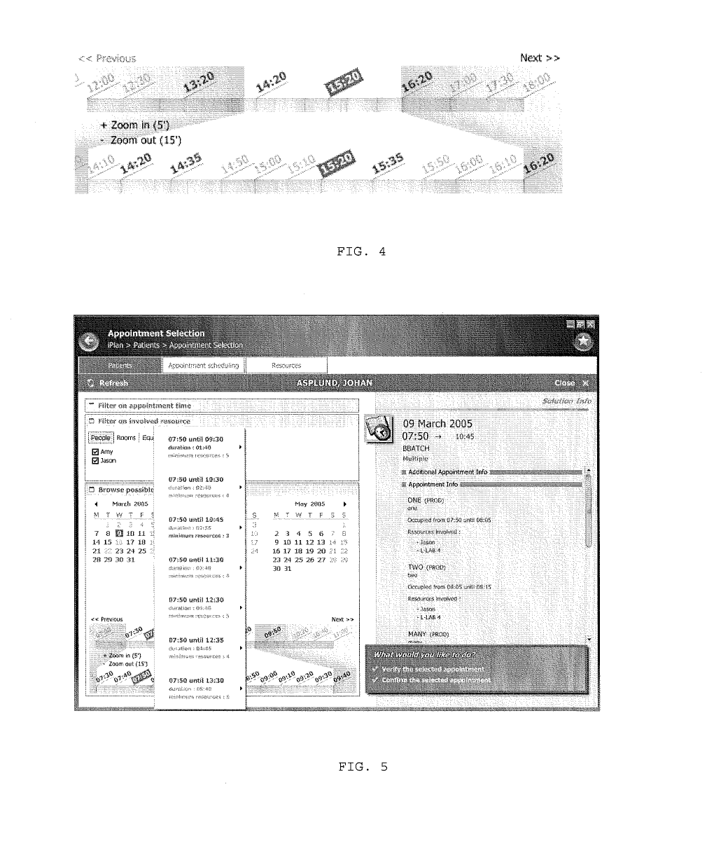

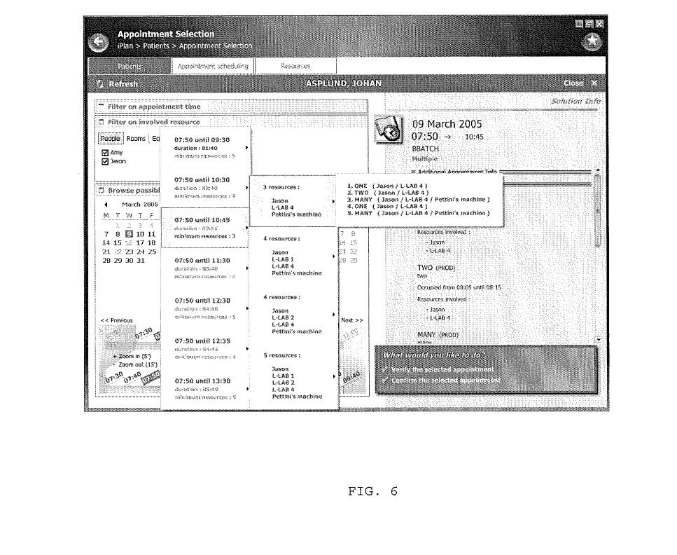

Zoomed to 10 minutes resolution: see FIG. 4.

Additionally, combined with the calendar solution days (similarly highlighted or not), navigating to next solution days is possible by means of next & previous as illustrated by FIGS. 1 and 2.

Finally, when a certain start-time is agreed with the patient, the user interface according to the present invention solution allows the user to switch between possible resource combinations for that time of day.

This is done by a right mouse click on the particular time of day.

As shown in FIGS. 4 and 5, in a first view, the total duration of each different solution is presented, together with the number of resources used.

This can be the basis of a first decision, typically:
patient focused: lowest total duration
resource/hospital oriented: lowest number of resources involved

Further on, each resource combination is shown for the particular choice, and the user can switch combinations. (still on that particular timeslot)

Below aspects of the underlying scheduling method, more specifically of the method of generating a solution space (comprising possible solutions), are described extensively.

Before explaining the general principles of the method according to the current invention, the method is first explained by working out a specific example, which is also one specific embodiment of the current invention.

According to the example, an appointment needs to be scheduled to examine a patient by means of a scanner. The patient needs to undress before and to dress again after the scan.

The exam itself takes 2 hours. Both for undressing and dressing one hour is provided. After the patient has undressed, he does not want to wait for the exam. When the exam is finished, he accepts that he may have to wait up to one hour before he can dress again.

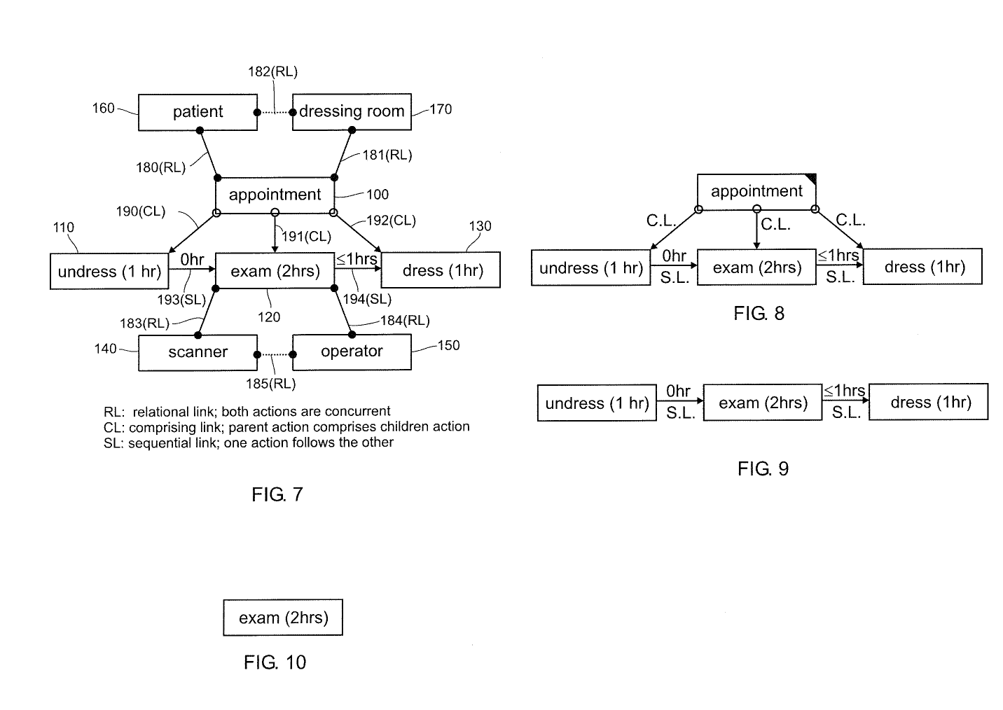

FIG. 7 describes the actions that are part of the appointment and the relations between them. The appointment (100) action comprises three other actions: the undressing (110) action, the actual exam (120) action and the dressing (130) action. This comprising relationship is represented by three comprising links (190, 191, 192) between the individual actions (110, 120, 130) and the appointment (100) action. The appointment (100) action is called a parent relative to the undressing (110), the actual exam (120) and dressing (130) actions which are called children. Because of the parent-child relationship of a comprising link (190, 191, 192), it is not symmetrical.

An action is defined as being “atomic” when it does not comprise other actions. For example, the undress (110) action is atomic, but the appointment (100) action is not.

The undressing (110), the actual exam (120) and dressing (130) actions follow sequentially and this relationship is represented by the sequential links (193, 194). The sequential nature implies that such a link is not symmetrical, as the arrows in FIG. 7 also indicate.

The exam (120) can only be carried out when the scanner (140) is available. This kind of relationship is represented by a relational link (183). In addition does carrying out the exam require the availability of an operator, so a relational link (184) also exists between the exam and the operator (150). A relational link between two actions indicates that both actions can only be carried out at the same time. From this follows that such a link is by nature symmetrical and transitive. The transitivity is expressed in FIG. 7 by the dotted line (185) between the scanner and operator action.

In a more general case, a procedure or exam is preceded by a pre-op action and followed by a post-op action. In a more general case an action refers to an activity related to a resource. Such a resource can be a patient, a physician, a nurse, an operator a diagnostic or treatment apparatus, a examination or treatment room, or any other kind of resource with which an activity can be associated. The resource can or can not be related to the domain of healthcare. The activity can be the use of equipment, the presence of a person, the occupation of a facility or any other activity that refers to the use or availability of any resource. In a more general case any topology of any number of actions related by comprising, relational or sequential links is possible.

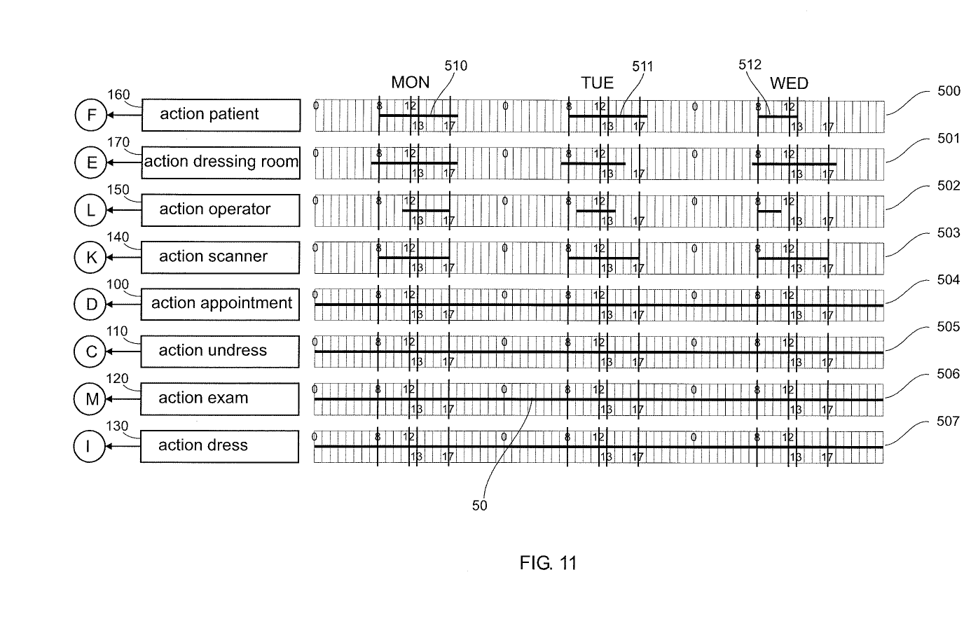

FIG. 11 shows how with each action (100, 110, 120, 130, 140, 150, 160, 170) in FIG. 7 a corresponding time window (501-507) is associated. A time window consists of a linked list of non contiguous time segments, each segment having a beginning and an ending time. For example, for the patient (160) action, the linked list consists of the time segments (510, 511, 512).

A time window can represent the range of time when an action can potentially occur. However, a time window can also represent a range of time when the action can start or when it can end.

In the example in FIG. 11, the time windows (500-503) of the patient (150), the dressing room (170), the scanner (140) and the operator (150) are part of the problem definition data. These time windows represent constraints imposed by the corresponding resources. The time windows (504-507) of the undressing (110), exam (120) and dressing (130) actions and of the appointment (100) as a whole, however, are initially undetermined, as they are the subject of the solution that has to be calculated for the scheduling problem. An undetermined time window is represented as one contiguous time segment with the length of the time window. For example, 508 is the initial time window associated with the exam action (120). As a solution for the time scheduling problem is being processed according to the current invention, the number of segments of an undetermined time window may change and the beginning and end times of the remaining time segments may become increasingly more focused, until they represent a situation that is consistent with all the constraints imposed by the resources.

Since the constraints imposed by the resources are represented by relational (180-185), comprising (190-192) and sequential (193, 194) links, processing the solution essentially comes down to working out these links.

When working out the links, a number of different cases are to be distinguished that correspond with the different nature of the links (relational, comprising or sequential), the interpretation of the time window of the action (start times, end times or action times), and the relative location of the time segments (the way that the time segments in the time windows of the linked actions overlap). The result of processing a link involves adjusting the time segments in the time windows corresponding to the linked actions in a way that they become consistent with the constraints imposed by the corresponding resources.

In the following paragraphs the processing of the different links is discussed.

First Case: Time Window Processing for Actions Connected through Relational Links

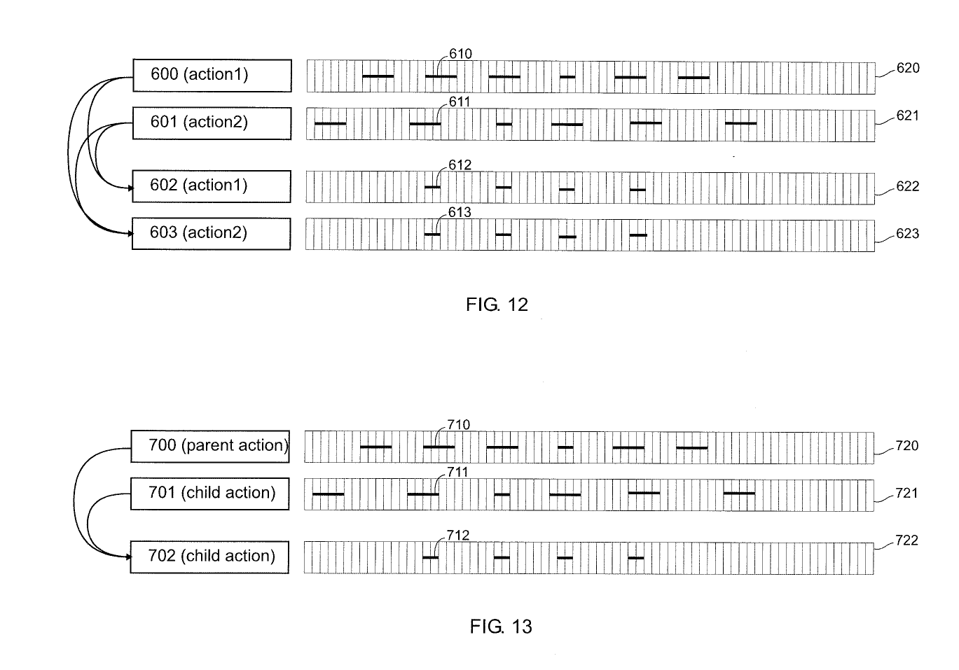

FIG. 12 illustrates a number of situations for actions connected through relational links, of which the time segments occur in different relative positions (overlapping and non-overlapping). The interpretation of the time windows (620-623) is that the represent the time during which the action (600-603) can take place. Since the meaning of a relational link is that the two actions (600,601) can only take place simultaneously, the effect of working out the link is that each time window (620,621) should be replaced by a time window (622,623) that consists of time segments (612,613) that are the cross sections of the time segments (610,611) in the original time windows.

Because of the transitive nature of a relational link, if an action has more than one relational link—directly or indirectly—to another action, the time windows of all the actions are to be replaced by a time window of which the time segments are the cross sections of all the time segments of the time windows of all the is related actions.

Second Case: Time Window Processing for Actions Connected through Comprising Links

FIG. 13 illustrates a number of situations for actions connected through comprising links, of which the time segments occur in different relative positions (overlapping and non-overlapping). The interpretation of the time windows (700-702) is that the represent the time during which the action can take place. The meaning of a comprising link is that the time segments (711) of a child action (701) have to occur within the time segments (710) of the time window (720) of the parent action (700). This is achieved by replacing the time segments (711) of the time window (721) of the child action (701) by the cross section (712) of themselves (711) with the time segments (710) of the time window (720) of the parent action (700).

Third Case: Time Window Processing for Actions Connected through Sequential Links

The following terms are introduced or clarified:
time window of an action: linked list of time segments describing when an action can take place.
time window of start times of an action: linked list of time segments describing when said action can start;
time window of end times of an action: linked list of time segments describing when said action can end;

The time window of an action, the time window of start times of the same action and the time window of end times of that same action are interrelated.

Referring to FIG. 15 and according to an embodiment of the current invention, a time window (921) representing start times (911) of an action is calculated from a corresponding time window (920) representing said action, by subtracting from the end times of the time segments (910) in the latter time window (920) the duration (930) of said action.

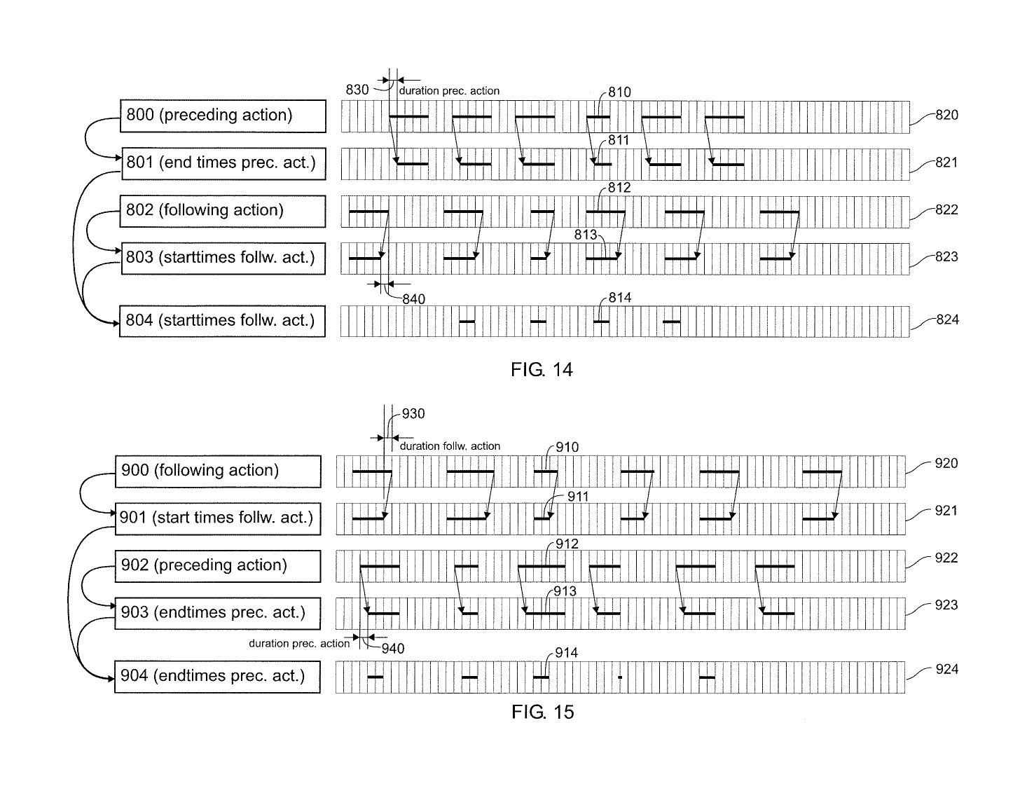

Referring to FIG. 14 and according to an embodiment of the current invention, a time window (821) representing end times is of an action is calculated from a corresponding time window (820) representing said action, by adding to the start times of the time segments (810) in the latter time window (820) the duration (830) of the action.

According to an embodiment of the current invention time windows representing start times and end times of an action are also interrelated by shifting the start and end times in the time segments by the duration of the action.

According to one embodiment of the current invention, when a first preceding action (800, 902) is followed by a second following action (802, 900), certain restrictions are applied on both the start and end times of both actions.

A first restriction involves the start times of a following action in order to achieve that that the start times of a following action can never be earlier than the earliest end time of any of the preceding actions. According to one aspect of the current invention, this effect is achieved by replacing the time segments (813) of the start times (823) of the following action (802) by the cross section (814) between themselves (813) and the time segments (811) of the end times (821) of the preceding action (800).

A second restriction involves the end times of the preceding action in order to achieve that the end times of a preceding action can never be later than the latest start times of any of the following actions. According to one aspect of the current invention, this effect is achieved by replacing the time segments (913) of the end times (923) of the preceding action (902) by a cross section (914) between themselves (913) and the time segments (911) of the start times (921) of the following action (900).

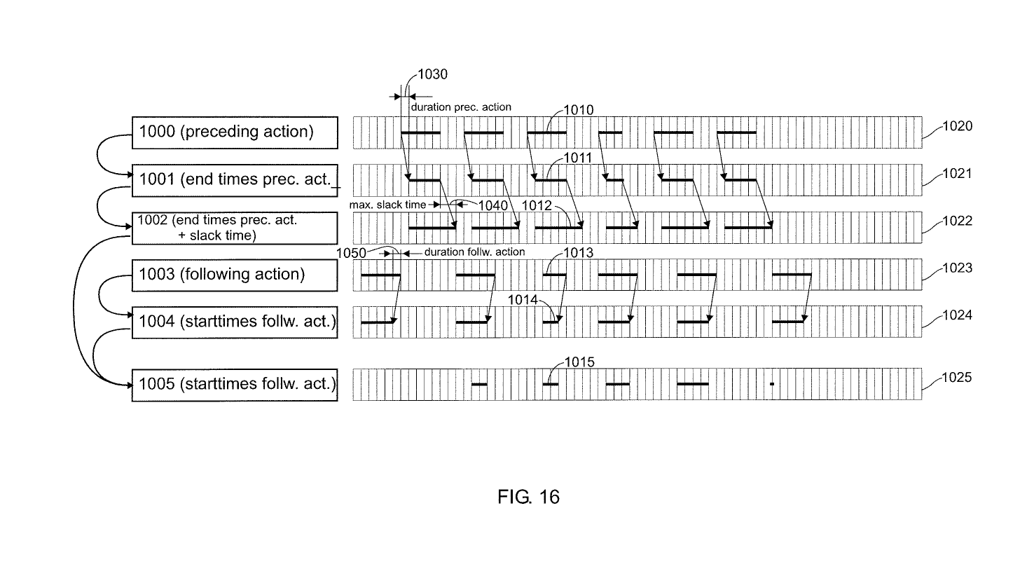

In the case that slack time is allowed between two actions, the end times of the time segments of the preceding action are preferably extended by the maximum allowed slack time, prior to applying said first restriction. Referring to FIG. 16, the time window (1020) of the preceding action (1000) is used to calculate the time window (1021) of the end times (1001) of the preceding action (1000) by shifting the start times of the time segments (1010) forward by the duration (1030) of the preceding action (1000). Following that, the segments (1011) of the time window (1021) of the end times (1001) of the preceding action are extended by the maximum slack time (1040) to yield the time segments (1012) of the time window (1022) of the end times (1002) of the preceding action plus the slack time. To obtain the time window (1024) of the start times of the following action (1004), the end times of the segments (1013) of the time window (1023) of the following action (1003) are shifted backwards by the duration (1050) of the following action (1003). The segments (1015) of the time window (1025) of the start times of the following action (1005) are obtained by making the cross section between the time segments (1012) and the time segments (1014).

Working out a sequential link between two actions involves applying the two above restrictions.

Having described how according to the current invention:
relational links are processed (1);
composite links are processed (2);
the relation between time windows representing actions, start times and end times (3) is processed;
sequential links are processed (4);
slack time is processed in sequential links (5).
   we proceed next by working out the example that was earlier introduced according to the principles of the current invention.

The problem that has to be resolved is finding the time window representing the start time(s) for the exam.

A first step consists of working out the relational links in FIG. 7.

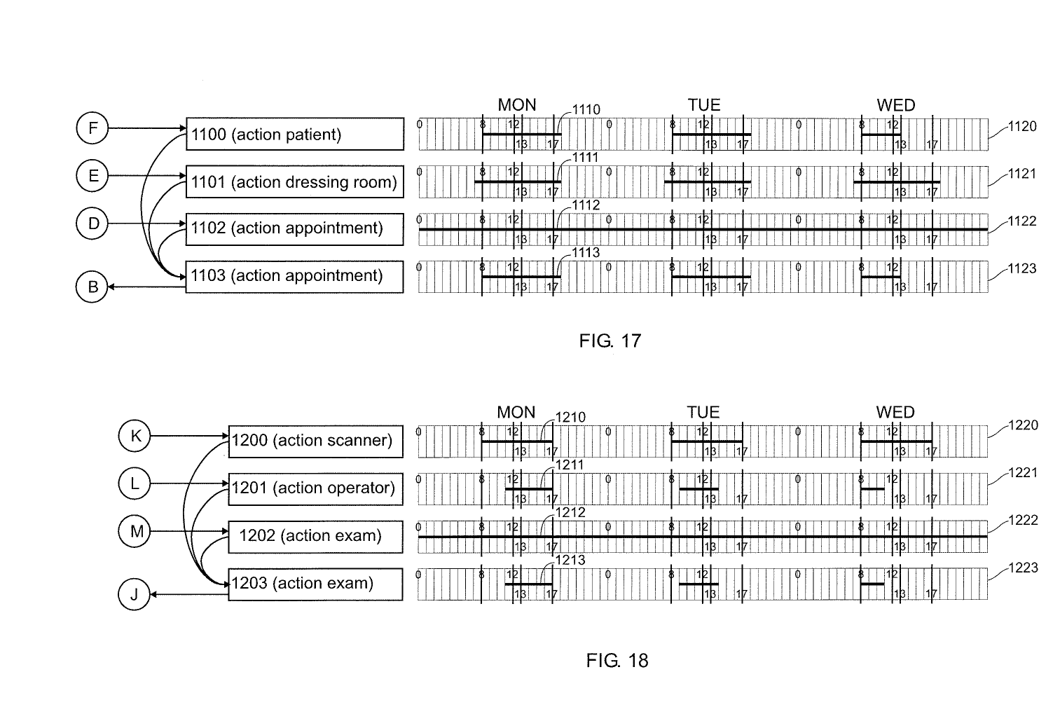

Referring to FIG. 17, this is done by using the general principles according to the current invention that were earlier explained by means of FIG. 12.

Similarly, referring to FIG. 18, the relational links can be worked out between the exam, the operator and the scanner.

After this operation, the graph in FIG. 7 can be reduced to the one in FIG. 8, with the notion that he time windows associated with the appointment and the exam actions are not the original ones, but the ones that were obtained from the previous step.

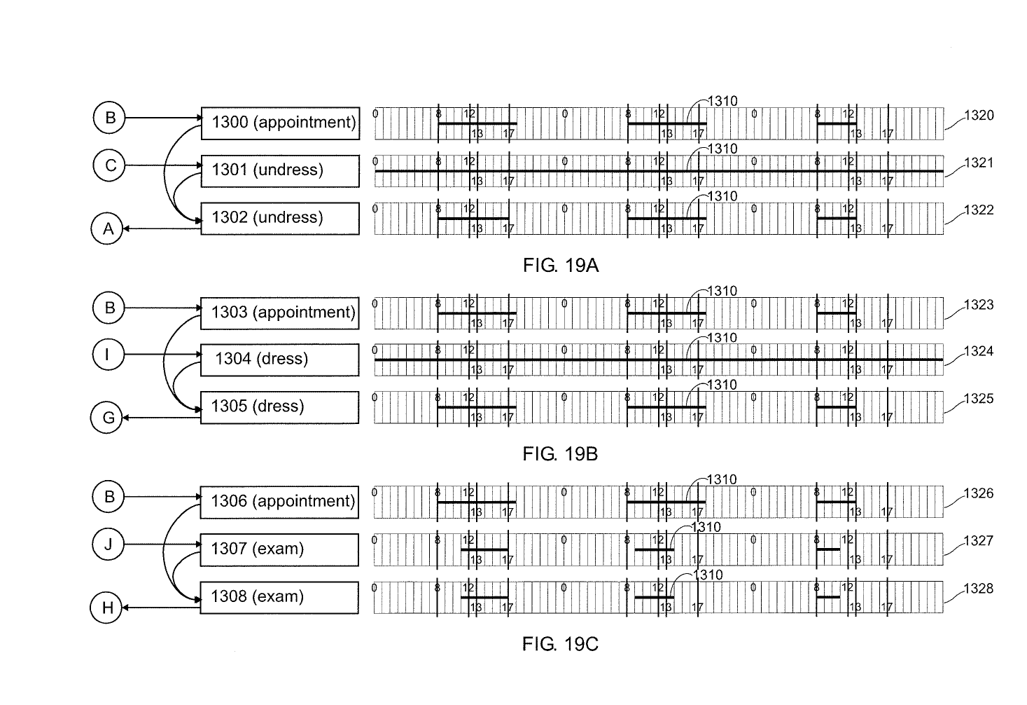

A second step consists of working out the comprising links in the graph in FIG. 8. According to the current invention, this is achieved by processing the time segments in the time windows of the undress, exam and dress actions so that they fall within the time segments of the time window of the appointment action. This is demonstrated in FIG. 19A, 19B and 19C using the general principles of the current invention that were earlier explained by means of FIG. 13.

After this operation, the graph in FIG. 7 or FIG. 8 can be reduced to the one in FIG. 9, with the notion that he time windows associated with the undress, exam and dress actions are not the original ones, but the ones that were obtained from the previous step.

The third step consists of working out the constraints imposed by the sequential links.

The exam action is preceded and followed by another action. According to one aspect of the current invention, this has implications on start and end times of the time segments of the corresponding time windows.

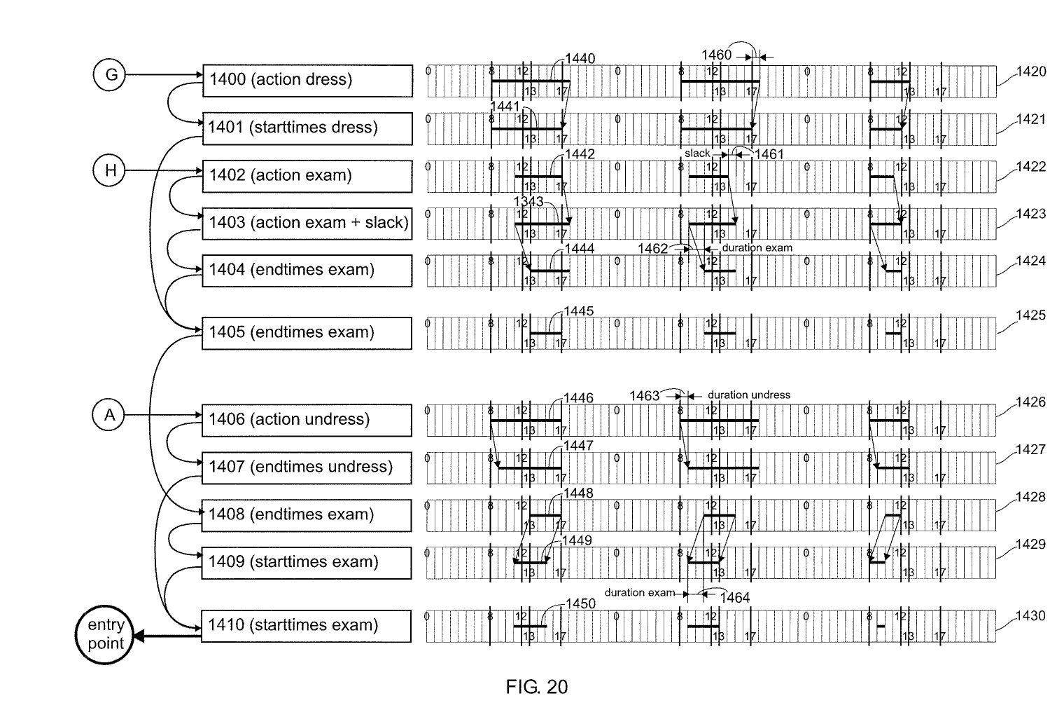

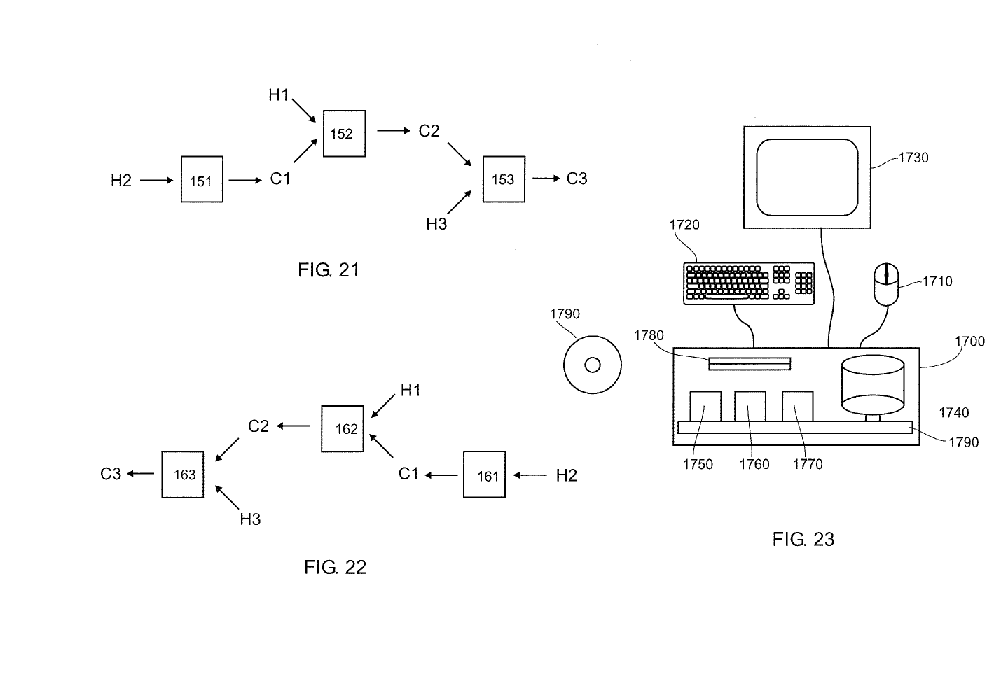

Referring to FIG. 20, the start times (1310) of the exam should never be earlier than the earliest end times (1307) of the undress action, and the end times (1303) of the exam including slack time should never be later than the latest start times (1301) of the dressing action, according to the general principles that were earlier explained by means of FIGS. 14, 15 and 16.

After this operation, the graph in FIGS. 7, 8 and 9 can be reduced to the one in FIG. 10, with the notion that he time window associated with the exam actions are the ones that were obtained from the previous step.

Introducing Deductive and Inductive Logic

According to a preferred embodiment of the current invention, an inductive logic method is used to control the processing of the time windows as opposed to deductive logic. These terms are explained in more detail.

Generally speaking, deductive logic starts with variables of which the values are known (called “the hypotheses”) and deduces step by step according to a predefined flow the value of the variable for which a solution is sought (called the “final conclusion”). This processing occurs through the calculation of the value of intermediate values (called “intermediate conclusions”).

In deductive logic, the information processing flow itself is the subject of the programming and as a result, once it has been programmed, it is fixed. Therefore, deductive logic programming is efficient for those problems of which the taxonomy of relations between variables is fixed, and only the values of the hypotheses are subject to change.

An example of a deductive logic method is shown in FIG. 22. H1, H2 and H3 are the basic hypotheses. Processing (151) the hypothesis H2 results in the intermediate conclusion C1. Processing (152) the conclusion C1 and the hypothesis H1 results in the intermediate conclusion C2. Processing (153) the conclusion C2 and the hypothesis H3 then leads to the final conclusion C3.

In contrary, the entry point for an inductive logic method according to the current invention is the final conclusion itself of which the value is initially unknown. By means of a set of inductive steps that take the form of an exploration process, the data of the hypotheses is first gathered and then systematically processed to calculate the final conclusion.

An inductive step to calculate an (intermediate) conclusion comprises determining what other variables are needed to calculate said (intermediate) conclusion. There are two possibilities:
1) Either the values of the variables that are needed are known because they are either hypotheses or intermediate conclusions of which the value has been earlier determined; in that case the variables can be processed to obtain the (intermediate) conclusion.
2) Or at least one of the variables that are needed is an intermediate conclusion of which the value has not been determined yet; in that case this (intermediate) conclusion initiates a new inductive step.

The subject of the programming in an inductive logic method is not a deductive information processing flow, but a rule set that manages the inductive steps.

Developing a rule set for an inductive method involves determining:
1) the nature (classes) of the variables (intermediate conclusions) that are needed to calculate a conclusion;
2) for each nature (class) of a variable (intermediate conclusion) determining what kind of processing on what other variables (other intermediate conclusions or hypotheses) is needed to calculate the result of said (intermediate) conclusion.

Unlike in a deductive logic method, the problem definition now not only states the values of the hypothesis, but also the taxonomy of the relations between the variables. This allows for far greater flexibility when solving problems that have different taxonomies of relations between variables. Once the rule set has been programmed, problems with a wide variety of taxonomies of relations between the above variables can be solved using the same program.

An example of using an inductive logic method is presented in FIG. 23. The entry point is a call to calculate the value of the variable C3. The rule set dictates that the variable C3 requires the processing of two other variables being H3, of which the value is known since it is a hypothesis, and the intermediate conclusion C2, of which the value at this point is unknown. The latter causes a new inductive step to calculate the unknown variable C2. The rule set dictates that the variable C2 requires the processing of two other variables H1, of which the value is known since it is a hypothesis, and of the intermediate conclusion C1, of which the value at this point is unknown. The latter causes a new inductive step to calculate C1. The rule set dictates that the variable C1 requires the processing of the variable H2, of which the value is known. This results in the processing of H2 to obtain C1. Now that C1 is known, this results in the processing of C1 and H1 to calculate C2. Now that C2 is known, this results in the processing of C2 and H3 to calculate the final conclusion C3.

### PREFERRED EMBODIMENT BASED ON INDUCTIVE LOGIC

According to the current invention, the solution of the scheduling problem stated in the above example is preferably carried out by using an inductive logic method.

According to one embodiment, the following classes or variables are used for managing resources:
time window related to an action
time window related to the start times of an action
time window related to the end times of an action

According to the same embodiment the inductive logic is managed by a set of three rules:
a first rule dictates that obtaining the value of a variable of the type “start times of an action” requires the processing of the value of the “end times of that action” and the value of “the previous action”.
a second rule dictates that obtaining the value of a variable of the type “action” requires the processing of the values of the “parent actions” and the “related actions”.
a third rule dictates that obtaining the value of a variable of the type “end times of an action” requires the processing of that same “action”, the “slack time” and “the following action”.

In a more general case other sets of rules can be selected that however yield equivalent results and also fall within the scope of the current invention. This follows from the fact that the classes of variables in the above rule set are related to each other by simple relationships.

We have found that the above set of three classes of variables in combination with the above three rules provides a self contained method than enables resource scheduling and management of a wide variety of situations.

The method according to the current invention processes time windows and results in a time window that generally comprises a plurality of time segments, each one indicating a single solution of when the corresponding action can take place (or start). The method hence produces not just one solution for the scheduling problem, as in the prior art, but a complete set of solutions.

The method according to the current invention can be used for any resource scheduling and management problem that can be modelled as a set of actions corresponding to resources that are related by a combination of comprising, relating and sequential links and slack time.

Having described the general principles of the current invention we proceed by working out the example that was earlier introduced.

Referring to FIG. 20, the method starts by instantiating a variable start times exam, which is the final conclusion of the scheduling problem.

The symbols in the circles on one of the FIGS. 17 to 20 indicate references to the same symbols in circles in one of the other figures.

Since the value of the variable start times exam at this point is unknown, this induces an inductive step (IS1). The first rule according to the current invention dictates that in order to calculate the value (1410) of the start times of the exam, the values (1408=1405) of the end time of the exam action and (1406=1302) of the undress action are needed. Since none of these values are known at this time, this causes two new inductive steps: a first one (IS2) to enable the calculation of the value (1406=1302) of the undress action and a second one (IS3) for the calculation of the value (1408=1405) of the end times of the exam.

We proceed by first explaining the inductive step (IS2). Referring to FIG. 17 to 20, the second rule dictates that in order to calculate the value (1406=1302) of the undress action requires the processing of the value (1300=1103) of the appointment action which is the parent action. Since the value (1300=1103) of the appointment action is not known at this time, this induces again an inductive step (IS4) for the calculation of that variable. Since this variable (1300=1103) appointment is of the type “action”, the same (second) rule applies, requiring the processing of the values of related dressing room (1101) and patient (1100) actions. The values of these actions are known since they are hypotheses, so this enables to calculate the value of the appointment (1300=1103) action and subsequently of the undress (1406=1302) action.

We next proceed by describing the inductive step (IS3). Referring to FIG. 17 to 20, the third rule dictates that the calculation of the value (1408=1405) of the end times of the exam requires the processing of the value (1402=1308) of the exam action and of the value (1400=1305) of the dress action. Since the variable (1402=1308) of the exam action is of the type “action”, the second rule applies, and this requires the processing of the values of the parent appointment (1306=1103) action, and of the related scanner (1200) and operator (1201) actions. The value (1306=1103) of the parent appointment action is calculated the same way as in the inductive step (IS2). The values (1200, 1201) of the relating actions are known, since they are hypotheses, so this enables to calculate the value of the exam (1402=1308) action. Since the variable (1400=1305) is also of the type action, the second rule is applied once more, leading to the processing of the values of the variables (1303=1103) and (1304=1101). At this point the calculation of the value (1408=1405) of the end times of the exam can be completed and subsequently the calculation of the value (1410) of the start times of the exam.

The above mentioned invention is preferably implemented using a data processing system such as a computer. An embodiment of such a system (1700) is shown in FIG. 23. A computer comprises a network connection means (1750, a central processing unit (1760) and memory means (1770) which are all connected through a computer bus (1790). The computer typically also has a computer human interface for inputting data (1710, 1720) and a computer human interface for outputting data (1730). According to one embodiment, the computer program code is stored on a computer readable medium such as a mass storage device (1740) or a portable data carrier (1790) which is read by means of a portable data carrier reading means (1780).

Having described in detail preferred embodiments of the current invention, it will now be apparent to those skilled in the art that numerous modifications can be made therein without departing from the scope of the invention as defined in the appending claims.

1. A user interface for an appointment scheduling system wherein
a first displayed time line on which possible solutions which are created, are indicated, said solutions being in the form of a time or time slot available for scheduling an appointment within a preset period of time given preset constraints and availability of resources,
the indicated possible solutions being arranged so that responsive to user selection of one of said indicated possible solutions a period surrounding the selected possible solution is blown up and simultaneously displayed on a second time line, said display resulting in a double time line and
possible solutions within said period on the second time line are indicated and are arranged to be selectable for a user.

2. A user interface according to claim 1 wherein said preset period is one day.

3. A user interface according to claim 1 wherein said preset period is a part of a day and wherein sliding means are provided upon activation of which the user can slide to display of a period pertaining to another part of the day.

4. A user interface according to claim 1 wherein on said first time line a number of times are indicated and wherein possible solutions are highlighted.

5. A user interface according to claim 1 wherein on said second time line a number of times are indicated and wherein possible solutions are highlighted.

6. A user interface according to claim 4 wherein said times are equidistant.

7. A user interface according to claim 4 wherein said times are starting points of time slots in which an appointment can be scheduled.

8. A user interface according to claim 4 wherein the distance between said times can be set by the user.

9. A user interface according to claim 5 wherein said second time line is displayed parallel with said first time line.

10. A user interface according to claim 1 wherein upon selection of a displayed solution a number of corresponding combinations of resources and/or duration of an appointment is displayed.

11. A method for facilitating appointment scheduling, comprising:
displaying a first displayed time line on which possible solutions which are created, are indicated, said solutions being in the form of a time or time slot available for scheduling an appointment within a preset period of time given preset constraints and availability of resources;
blowing up indicated possible solutions in response to user selection of one of said possible solutions in a period surrounding the selected possible solution and simultaneously displaying on a second time line, resulting display of a double time line; and
enabling user selection of possible solutions within said period on the second time line.

12. A method according to claim 11, wherein said preset period is one day.

13. A method according to claim 11, wherein said preset period is a part of a day and further comprising enabling a user to display of a period pertaining to another part of the day.

14. A method according to claim 11, further comprising indicating a number of times and highlighting possible solutions on said first time line.

15. A method according to claim 11, further comprising indicating a number of times and highlighting possible solutions on said second time line.

16. A method according to claim 14, wherein said times are equidistant.

17. A method according to claim 14, wherein said times are starting points of time slots in which an appointment can be scheduled.

18. A method according to claim 14, wherein the distance between said times can be set by the user.

19. A method according to claim 11, further comprising displaying said second time parallel with said first time line.

20. A method according to claim 11, further comprising displaying a number of corresponding combinations of resources and/or duration of an appointment upon selection of a displayed solution.

21. A user interface for an appointment scheduling system wherein
a collection of all appointment solutions is created, an appointment solution being a time slot on which all present constraints are met and on which the required resources are available,
a first displayed time line on which time slots containing at least one of the appointment solutions are indicated, said indicated time slots being selectable by the user, and
the indicated possible solutions being arranged so that responsive to user selection of one of said time slots a second time line displays a period surrounding the selected time slot as blown up, wherein the appointment solutions are indicated and selectable by the user.

22. A user interface according to claim 21 wherein on said first time line a number of times are indicated and wherein possible solutions are highlighted.

23. A user interface according to claim 21 wherein on said second time line a number of times are indicated and wherein possible solutions are highlighted.

24. A user interface according to claim 23 wherein said times are equidistant.

25. A user interface according to claim 23 wherein said times are starting points of time slots in which an appointment can be scheduled.

26. A user interface according to claim 23 wherein the distance between said times can be set by the user.

27. A user interface according to claim 21 wherein said second time line is displayed parallel with said first time line.

28. A user interface according to claim 21 wherein upon selection of a displayed solution a number of corresponding combinations of resources and/or duration of an appointment is displayed.
